(19) United States
(12) Patent Application Publication
(10) Pub. No.: US 2022/0369540 A1
(43) Pub. Date: Nov. 24, 2022

(54) SENSOR FOR AGRICULTURAL PLANTER CLOSING WHEEL

(71) Applicant: Harvest International, Inc., Storm Lake, IA (US)

(72) Inventors: Jeffrey Alan Sivinski, Cherokee, IA (US); Byron James Friesen, Storm Lake, IA (US)

(21) Appl. No.: 17/664,115

(22) Filed: May 19, 2022

Related U.S. Application Data
(60) Provisional application No. 63/201,957, filed on May 20, 2021.

(51) Int. Cl. A01C 5/06; G01P 3/481

(52) U.S. Cl. CPC A01C 5/068; G01P 3/481

(57) ABSTRACT

A sensor system on the closing wheels of an agricultural planter detects rotational speed of the closing wheels, and generates a signal corresponding to the rotational speed. If the speed is below an optimum or preset speed, the operator is notified that the wheels are not rotating properly or have stopped rotating, thereby indicating improper closing of the seed furrow after the seed is planted in the furrow. A sensor system provides a method of monitoring the function of the closing wheels and generating a signal corresponding to the rotational status of the closing wheels.

### CROSS REFERENCE TO RELATED APPLICATIONS

This application claims priority under 35 U.S.C. § 119 to provisional patent application U.S. Ser. No. 63/201,957, filed May 20, 2021. The provisional patent application is herein incorporated by reference in its entirety, including without limitation, the specification, claims, and abstract, as well as any figures, tables, appendices, or drawings thereof.

### FIELD OF THE INVENTION

The field of invention generally relates to agricultural planters, and specifically to closing wheel sensors on the planters to monitor rotation of the closing wheels.

### BACKGROUND OF THE INVENTION

All modern agricultural seed planting row units utilize a system that opens a seed furrow via angled disc openers, furrow forming “shoes” or flat blades. After the seed furrow is formed and the seed is placed in the furrow, the furrow must be closed with dirt to insure proper germination, emergence and growth.

Seed furrows are nearly all closed with wheels, discs, finger wheels, inverted finger disc, coulters and/or various rolling soil forming systems (collectively and generically referred to as closing wheels), all of which turn, rotate or roll about an axis. These systems push, pull and/or roll the soil to close the seed furrow and firm the soil around the seed that has been placed in the furrow.

Because these furrow closers are rolling systems, there can be situations where rocks, wire, corn plant root balls (large corn plant roots with soil still attached, from the previous season, that have been loosened with tillage), cover crop straw residue, and other foreign objects can be lodged in the closing wheels and cause the rolling closing systems to become plugged and stop or slow turning of the closing wheels. Additionally, these rolling furrow-closing systems roll on a bearing that can also fail and cause the wheels or discs to stop turning.

When the closing wheels/discs stop or slow their turning or rolling, the seed that has been planted, along with related fertilizer and insecticides that have been applied, can be pushed out of the seed furrow and will not grow properly. This condition creates loss to the farmer not only in wasted seed, fertilizer and insecticides, but also creates an economic loss of income from the crop in that row that did not grow, or did not maximize yield, or will require replanting the row for proper germination and growth of the plant.

Many of today's planters are quite large (60 ft-120 ft wide) and are equipped with many row units. Monitoring these row units to ensure that all closing wheel systems are operating correctly is very difficult, especially when planting in dusty conditions and in the dark. Because of the size of the planters and the new high-speed planters, visually monitoring the furrow closing wheel systems from the tractor is nearly impossible, and many acres of crops can be planted before the malfunctioning closing systems are detected.

Therefore, a primary objective of the present invention is the provision of a method and means for monitoring operation of the closing wheels to assure proper planting of seeds in the furrows.

Another objective of the present invention is the provision of a system for sensing proper and/or improper rotation of closing wheels to indicate whether seed furrows are being properly closed during the planting operation.

A further objective of the present invention is the provision of a sensor system for an agricultural planter which generates signals corresponding to rotation or non-rotation of the planter closing wheels.

Yet another objective of the present invention is the provision of a method of monitoring rotation of a furrow-closing wheel on an agricultural planter by detecting rotation of movement of in indicia on the closing wheels, such as bolts and nuts, during each rotation of the closing wheel.

Yet another objective of the present invention is the provision of a sensing system which notifies a farmer when closing wheels on an agricultural planter are not rotating properly.

A further objective of the present invention is the provision a method and means for generating signals corresponding to rotational speed of closing wheels on a planter row unit to indicate whether the closing wheels are rotating at the proper speed, a slowed speed, or have stopped rotation.

These and other objectives have become apparent from the following description of the invention.

### SUMMARY OF THE INVENTION

The closing wheel sensor system uses sensors to detect rotation of the wheels, disc, finger wheels inverted finger disc, coulters and/or various rolling soil forming systems (referred hereinafter, collectively, as “closing wheels” or “closers”), to detect when these systems stop turning, and alert the planter operator of the faulty condition.

The sensors are located on or adjacent to the closing wheel systems, which can have a large variety of designs. These sensors can detect rotation by sensor “pulses” from the sensor against a pulse generating component, such as a metal bolt, a finger, a hole, or a notch on a closing wheel to generate pulses. This pulsing or non-pulsing information is sent to the tractor cab-mounted computer control console, that continuously monitors all closing wheels and alerts the operator of the planter or autonomous vehicle control system when one or more of the closing wheels is not properly rotating. The pulse generating sensors may take various forms. Non-contact sensors can be used, such as optical, rotary, shaft, magnetic, or torque sensors. Alternatively, contact type sensors could also be used, such as a “whisker” type finger that contacts a disc, bolt or some type of mechanical system to break the electrical current and cause the alarm to sound.

As the wheels, disc, finger wheels, inverted finger disc, coulters and/or various rolling soil forming systems turn, the sensor can detect this rotation from the pulse generating component. If the closer rotation changes from a pre-determined rate, i.e., slows or stops, the sensor will alert the operator of the rotational change in a closing wheel, so that the problem can be fixed and returned to optimal planting.

Additionally, as agricultural systems become more automated and autonomous, detection of conditions that cause the planter to not work correctly will become more critical to avoid wasted seed and lost profits.

This system can eliminate wasted seed, fertilizer, insecticide, fuel and economic loss to the farmer, by alerting the operator of a malfunction in the closing system.

### BRIEF DESCRIPTION OF THE DRAWINGS

FIG. 1 is a perspective view of an agricultural row unit, such as those used for planting seeds, with the closer wheel or disc sensors of the present invention.

FIG. 2 is another rear perspective view of the row unit with the closing wheel/disc sensors of the present invention.

FIG. 3 is an enlarged rear perspective view of the closing wheel and disc with the sensors of the present invention.

FIG. 4 is a different rear perspective view of the closer wheel/disc with the sensors of the present invention.

FIG. 5 is an enlarged perspective view of one of the sensors of the present invention positioned adjacent to a closing disc.

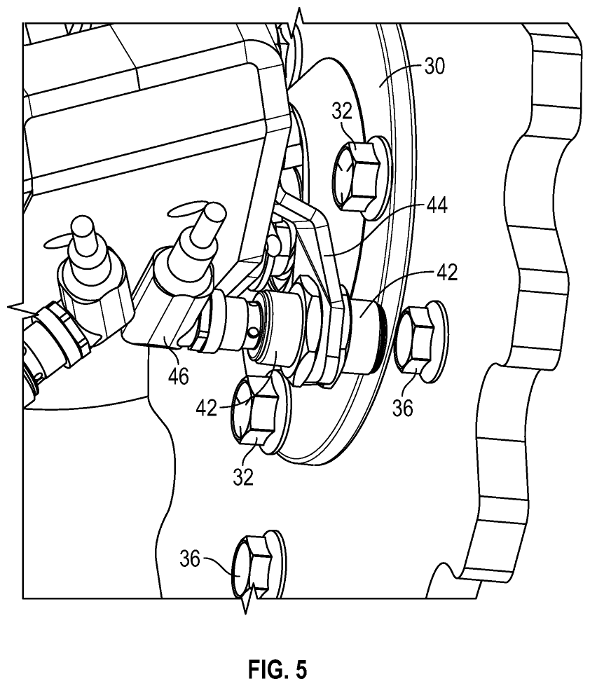

FIG. 6 is an enlarged view of one of the sensors of the present invention positioned adjacent to a closing wheel.

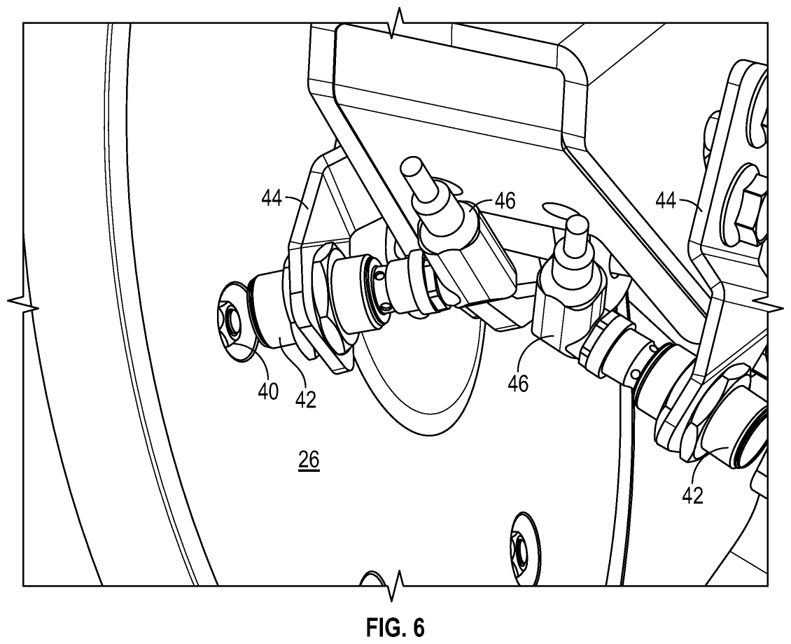

FIG. 7 is a rear elevation view of the closing wheel/disc with the sensors of the present invention.

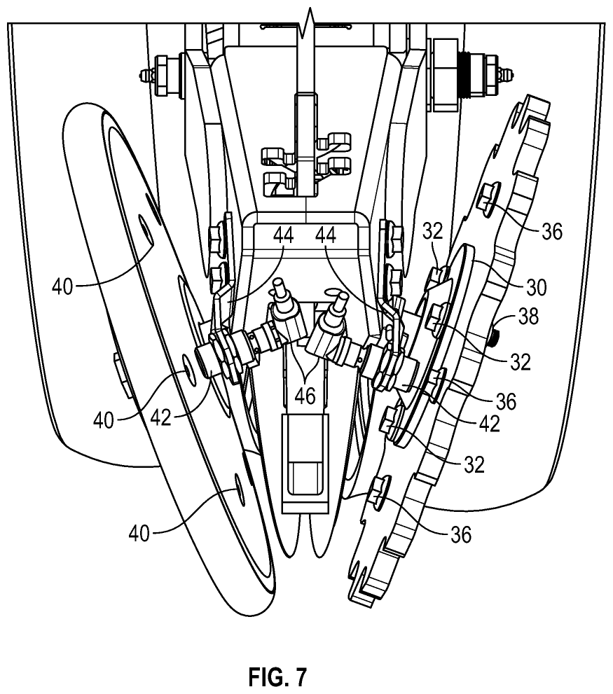

FIG. 8 is a top plan view of the closing wheel/disc with the sensors of the present invention.

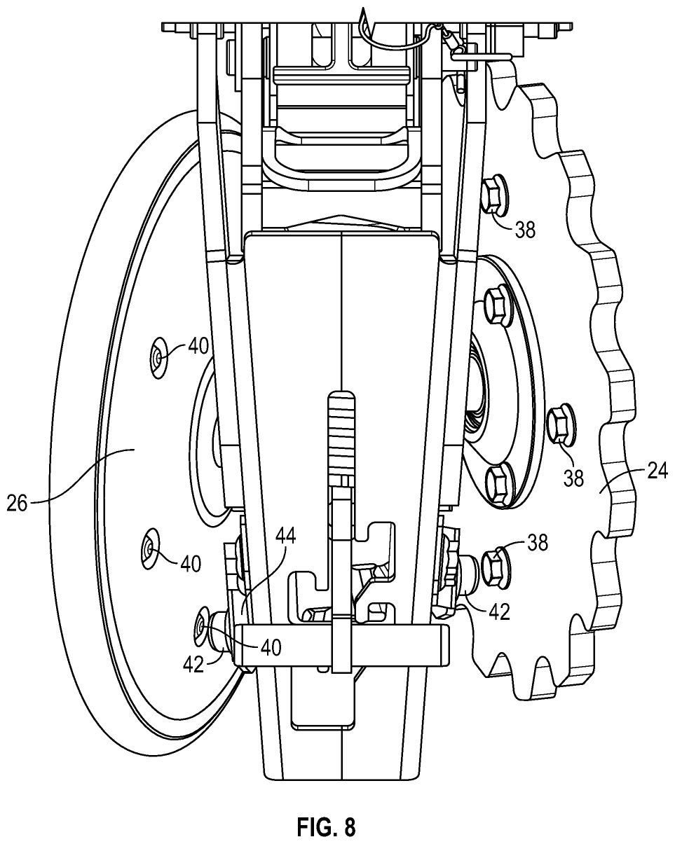

### DETAILED DESCRIPTION OF THE INVENTION

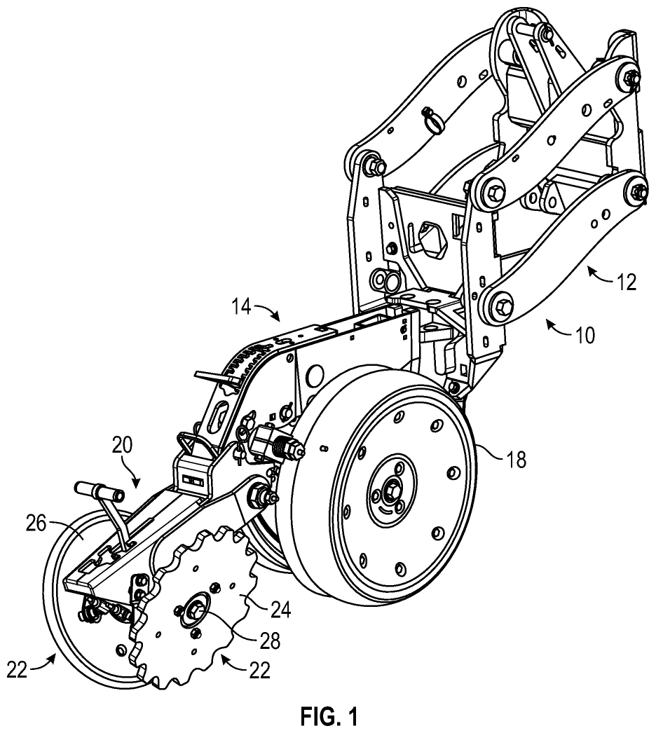

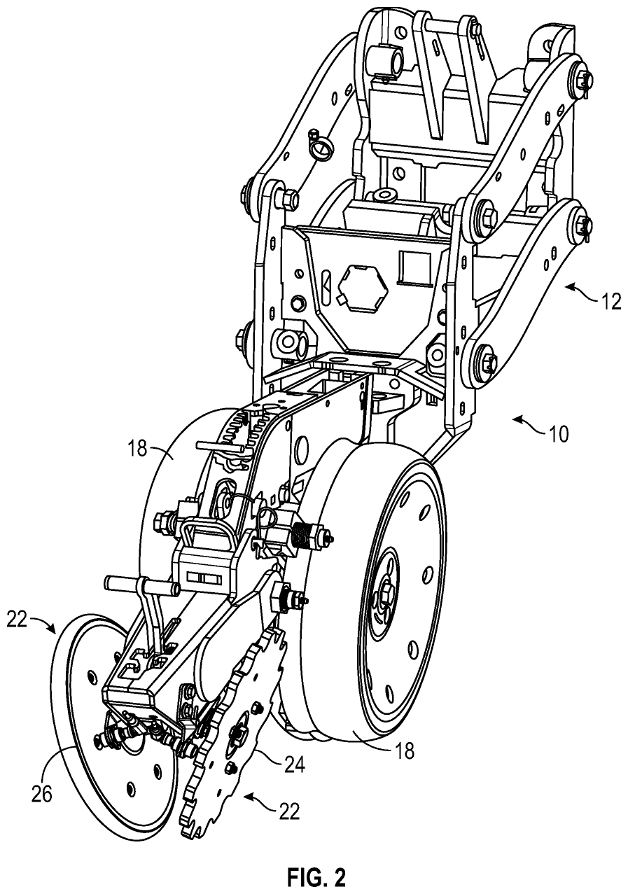

FIGS. 1 and 2 show an agricultural row unit 10 having a mounting bracket 12 for mounting the row unit 10 to a toolbar behind a tractor. The row unit includes a primary or front frame 14 which supports rotating discs 16 which form a furrow in the soil and a pair of rotatable gauge wheels 18 which control the depth of the furrow. A secondary or rear frame 20 is mounted to the front frame 14 and rotationally supports a pair of canted furrow closers 22. The furrow closers 22 may have various forms, such as the toothed disc 24 or a wheel 26. While FIGS. 1 and 2 show both the disc 24 and the wheel 26, it is understood that normally a pair of the discs 24 or pair of the wheels 26 would be used on the frame 20, rather than one disc 24 and one wheel 26, which are shown merely for illustrative purposes for different types of closers 22 which may be used. The closers 22 are mounted to a bushing in the frame 20 by a center bolt 28, and to a support plate 30 with bolts 32 extending through the plate 30 and the disc 24, and secured by nuts 34. The disc 24 also typically includes inner and outer plates which are fastened by a plurality of bolts 36 and nuts 38 which are arranged in a circumferential pattern approximately midway between the center bolt 28 and the perimeter edge of the disc 24. Similarly, the closing wheel 26 includes inner and outer components which are held together by a plurality of circumferentially arranged nut and bolt assemblies 40. The bolt heads and nuts of the assemblies 40 may be recessed, as shown in the drawings.

The above structure of the row unit 10, including the closer disc 24 and closer wheel 26, is conventional.

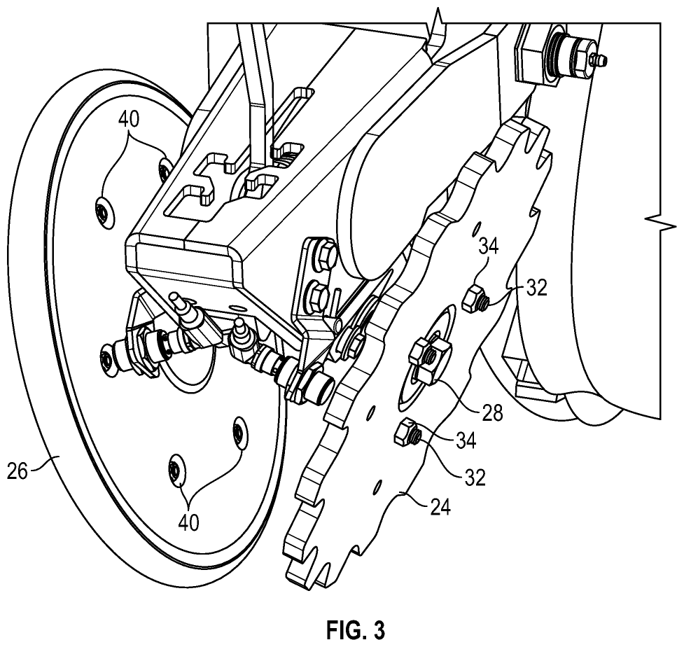

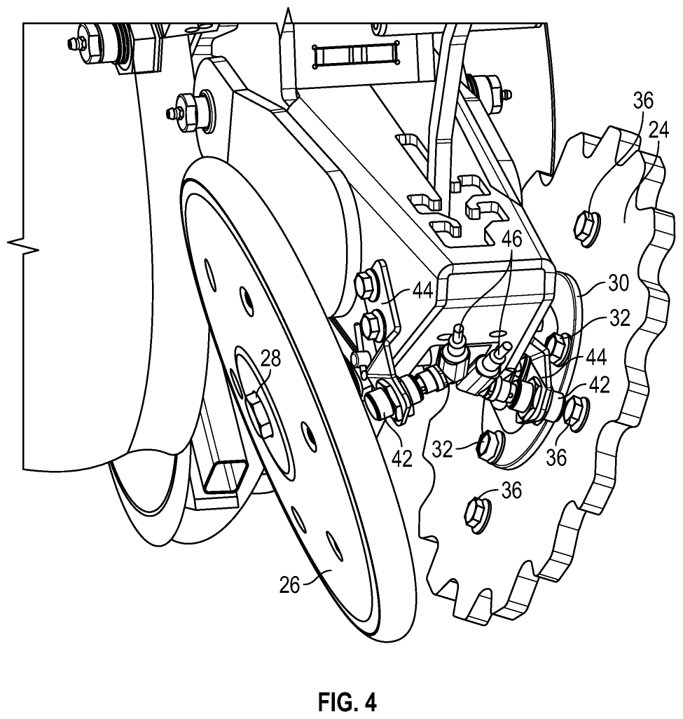

The present invention is directed toward sensors 42 which sense the rotational speed of the closers 22. Each closer 22 has its own sensor 42 which is mounted to an arm 44 extending from the frame 20 such that the sensor 42 is positioned adjacent to the nut and bolt assemblies 32, 34, 36, 38, or 40. Preferably, as seen in FIGS. 3 and 4, the sensors 42 reside near the rear end of the frame 20, and include a coupling 46 to which an electric wire can be connected for a hardwired communication between the sensor 42 and the computer or microprocessor in the cab of a tractor. Alternatively, the coupling 46 may be a transmitter to send a wireless signal to the computer microprocessor.

One example of a commercially available sensor 42 is an inductive sensor, IGC 207, model number IGB308 BAPK/US-104 sold by IFM Effector, Inc. in Malvern, Pa.

The nut and bolt assemblies 32, 34, 36, 38, 40 provide a pulse function when the closer 22 is rotating as sensed by the sensor 42 when the assembly rotates past the sensor 42. If the closer 24 is not rotating, the sensor 42 does not sense a pulse from the nut and bolt assemblies, thereby generating a signal to the computer microprocessor to notify the operator that rotation of the closer has stopped. Since non-rotating closers adversely affect the seed planted in the furrow, the operator can stop the tractor and correct the problem. This eliminates waste and maximizes crop yield by assuring proper rotation of the closers 22 for closing the furrows to achieve proper seed planting.

As a further option, the sensors 42 can also detect when the closer 22 is rotating at a slower speed than the ground speed of the tractor, and generate an appropriate signal to warn the operator of this problem, which may arise from an accumulation of mud or other debris on the closer disc 24 or wheel 26. The problem can then be corrected to restore the desired rotation to the closer 22, and thus restore proper planting with furrow closure.

The nut and bolt assemblies 32-40 are one example of a pulse generation/detection component for sensing by the sensors 42. Other components on the closers 22 can also be used for the pulse generation, such as a projection, a finger, a hole, or a notch on a closing wheel 22, which the sensor will detect to generate the signals.

Thus, the sensors 42 may generate a first signal corresponding to the proper rotation of the closers 22, a second signal indicating a slower than desired rotation of the closers 22, and/or a third signal indicating that rotation of the closer 22 has fully stopped due to some type of obstruction that needs to be cleared.

The embodiments, variations, and figures described above are provided as an indication of the utility and versatility of the present invention. Other embodiments that do not provide or otherwise utilize all of the features, processes and advantages set forth herein may also be utilized, without departing from the spirit and scope of the present invention. Such modifications and variations are considered to be within the scope of the principles of the invention as defined by the claims set forth below.

What is claimed is:

1. A sensor system for an agricultural planter having a pair of canted rotatable closers for closing soil in a furrow over a planted seed, the closers having a plurality of bolts and nuts extending in a circumferential pattern, the sensor system comprising:
a pair of sensors, each being positioned adjacent respective ones of the pair of closers to detect the bolts or nuts during rotation of the closer and to generate a signal corresponding to a rotational status of each closer.

2. The sensor system of claim 1 wherein each sensor sends a first signal to an operator when the bolts or nuts are sensed to indicate that the closer is rotating at a proper speed.

3. The sensor system of claim 2 wherein each sensor sends a second signal to the operator when the bolts or nuts are not sensed to indicate that the closer is not rotating.

4. The sensor of claim 3 wherein each sensor sends a third signal to the operator when the bolts or nuts are sensed to be rotating at a speed slower than the proper speed.

5. The sensor system of claim 1 wherein each sensor is connected to an arm extending from the frame.

6. The sensor system of claim 1 wherein the sensor includes a coupler to electrically couple to a monitor near the operator.

7. The sensor system of claim 1 wherein the sensor is an inductive sensor.

8. The sensor system of claim 1 wherein the sensor is a pulse sensor.

9. The sensor system of claim 1 wherein the sensor includes a transmitter to wirelessly transmit the signal.

10. A method of monitoring rotation of a furrow-closing wheel on an agricultural planter during planting of seeds, the closing wheel having a detector component, the method comprising:
positioning a sensor adjacent the closing wheel;
detecting rotational movement and lack of rotational movement of the detector component with the sensor;
sending signals from the sensor to an operator corresponding to a rotational status of the closing wheel.

11. The method of claim 10 wherein the signals are sent to a monitor in a cab of the agricultural planter.

12. The method of claim 10 wherein the signals are sent to a microprocessor which generates an alarm to notify the operator that rotation of the closing wheel has stopped.

13. The method of claim 10 wherein the signals change when rotation of the closing wheel changes.

14. The method of claim 10 wherein the signals include a first signal indicating a proper rotational speed of the closing wheel, a second signal indicating a slowed rotational speed of the closing wheel, and a third signal indications stopped rotation of the closing wheel.

15. The method of claim 14 further comprising discontinuing the planting operation when either the second signal or the third signal is received, and removing debris from the closing wheel associated with the second and third signals, and then resuming the planting operation.

16. The method of claim 10 wherein the sensor is a pulse sensor.

17. A method of improving seed planting operations of an agricultural seed planter having a plurality of row units, with each row unit having furrow opening wheels to form an open furrow and furrow closing wheels for closing the furrow, and a seed dispenser between the opening and closing wheels to dispense seeds into the open furrow before the furrow is closed, the method comprising:
sensing a rotational status of the closing wheels using a sensor adjacent each closing wheel;
generating a first signal for each closing wheel to indicate a first rotational speed of the closing wheel matching the ground speed of the planter during the planting operation;
generating a second signal for each closing wheel to indicate a second rotational speed of the closing wheel slower than the first rotational speed during the planting operation; and
generating a third signal for each closing wheel to indicate non-rotation of the closing wheel during the planting operation;
transmitting the signals to an operator;
the operator stopping the planting operation upon receipt of the second signal or the third signal; and
cleaning the closing wheel from which the second or third signals are generated before continuing the planting operation.

18. The method of claim 17 wherein the sensor for each closing wheel detects a bolt and nut assembly on the closing wheel.

19. The method of claim 17 wherein each sensor is an inductive sensor.

20. The method of claim 17 wherein each sensor is a pulse sensor.
